(19) United States
(12) Patent Application Publication
(10) Pub. No.: US 2026/0348356 A1
(43) Pub. Date: Nov. 5, 2026

(54) VEHICLE-BASED ENERGY GENERATION

(71) Applicant: Christopher John Anthony Coman, Worcestershire (GB)

(72) Inventor: Christopher John Anthony Coman, Worcestershire (GB)

(21) Appl. No.: 19/099,278

(22) PCT Filed: May 22, 2023
(86) PCT No.: PCT/GB2023/051340

§ 371 Date: Jan. 28, 2025

(30) Foreign Application Priority Data
Jul. 29, 2022 (GB) 2211082.9

(51) Int. Cl. F03D 3/04; B60L 8/00; B60L 50/60; F03D 3/00; F03D 9/32

(52) U.S. Cl. CPC F03D 3/0418; B60L 8/006; B60L 50/66; F03D 3/002; F03D 9/32; F05B 2240/133

(57) ABSTRACT

A transportation means 10 comprises at least one fluid inlet 14, a first duct 40, a second duct 20, and at least one generator 16, wherein the first duct 40 and the second duct 20 are arranged to receive a fluid flow from the at least one fluid inlet 14, and to direct the fluid flow to the generator 16, the generator being mounted transverse to a direction of travel of the transportation means 10 and arranged to generate energy from a passage of fluid from the at least one fluid inlet 14 through or over the generator 16, the generator 16 comprising a fluid flow capture mechanism comprising one or more blades extending from a central hub, and wherein the first duct 40 has an outlet directing fluid flow towards a lower portion of the blades of the generator 16 so as to lift the blades, and fluid from the second duct 20 is delivered to an upper portion of the blades of the generator 16, substantially over the central hub, the fluid flow capture mechanism being arranged to extract energy and drive the generator 16 from movement of the transportation means 10 through the surrounding fluid.

This invention relates to an apparatus and method of generating, storing and using energy derived from relative movement, including from renewable natural flow sources. This invention is particularly concerned with generating, storing and using energy generated by natural flow sources in a means of transportation.

### BACKGROUND

There is an increasing demand for the use of alternative renewable energy to supply the world's energy demands. As transportation develops there is an increasing demand for the use of emission free power in order to comply with increasingly rigorous emission requirements.

### BRIEF DESCRIPTION OF THE DRAWINGS

The invention will now be described by way of example only with reference to the accompanying drawings in which:

FIG. 1 is a schematic view of a prior art generator (see granted UK patent GB2543395B);

FIG. 2 is a schematic illustration of a vehicle in accordance with an aspect of the invention;

FIG. 3 is a schematic view of a generator for use in a transportation means in accordance with an aspect of the invention;

FIG. 4 is a schematic view of a turbine air foil assembly;

FIG. 5 is a partial schematic of a section of a vehicle in accordance with an aspect of the invention;

FIG. 6 is a schematic layout of the electrical system;

FIG. 7 is a first perspective view of a vehicle duct system arranged to direct a fluid around a generator;

FIG. 8 is a second perspective view of the duct system of FIG. 7;

FIG. 9 is a third perspective view of the duct system of FIG. 7;

FIG. 10 is a perspective view of the first duct in isolation, showing its lip; and

FIG. 11 is a close-up view of a portion of FIG. 9.

### DESCRIPTION OF THE INVENTION

According to a first aspect of the invention there is provided a means of transportation comprising a fluid inlet and at least one generator, the generator being arranged to generate energy from a passage of fluid from the fluid inlet through or over the generator.

The transportation means may comprise at least one motor arranged to propel the transportation means. The generator may be arranged to drive the or each motor.

For example, according to this first aspect of the invention there is provided a means of transportation comprising at least one motor arranged to propel the vehicle, a fluid inlet and at least one generator, the generator being arranged to generate energy from a passage of fluid from the fluid inlet through or over the generator and to (i) drive the or each motor, and/or (ii) to provide auxiliary power (e.g. for music, heating, or a charging port on board the means of transportation, such as for a vehicle occupant's mobile phone, and/or for storage for later use).

The or each generator is therefore driven by the a passage of fluid from the fluid inlet through or over the generator(s), and may use the fluid flow to assist in propelling the vehicle and/or to provide power for any other functions on board the transportation means, and/or to provide power which is stored for later use, or indeed fed to a grid.

The electricity generated by the generator may be used indirectly to drive the motor-for example, the generated electricity may be stored in a battery and used to power the motor at a later time instead of immediately. In addition, some of the electricity generated may be used for other purposes the generator may therefore also supply auxiliary power.

According to a second aspect of the invention there is provided a transportation means comprising at least one fluid inlet, a first duct, a second duct, and at least one generator, wherein the first duct and the second duct are each arranged to receive a fluid flow from the at least one fluid inlet, and to direct the fluid flow to the generator, the generator being mounted transverse to a direction of travel of the transportation means and arranged to generate energy from a passage of fluid from the at least one fluid inlet through or over the generator, the generator comprising a fluid flow capture mechanism comprising one or more blades extending from a central hub, and wherein the first duct has an outlet directing fluid flow towards a lower portion of the blades of the generator so as to lift the blades, and fluid from the second duct is delivered to an upper portion of the blades of the generator, substantially over the central hub, the fluid flow capture mechanism being arranged to extract energy and drive the generator from movement of the transportation means through/relative to the surrounding fluid.

The transportation means may comprise at least one motor arranged to propel the transportation means. The generator may be arranged to drive the or each motor.

For example, according to this second aspect of the invention, there is provided a transportation means comprising at least one motor arranged to propel the transportation means, at least one fluid inlet, a first duct, a second duct, and at least one generator, wherein the first duct and the second duct are each arranged to receive a fluid flow from the at least one fluid inlet, and to direct the fluid flow to the generator, the generator being mounted transverse to a direction of travel of the transportation means and arranged to generate energy from a passage of fluid from the at least one fluid inlet through or over the generator and to drive the or each motor, the generator comprising a fluid flow capture mechanism comprising one or more blades extending from a central hub, and wherein the first duct has an outlet directing fluid flow towards a lower portion of the blades of the generator so as to lift the blades, and fluid from the second duct is delivered to an upper portion of the blades of the generator, substantially over the central hub, the fluid flow capture mechanism being arranged to extract energy and drive the generator from movement of the transportation means through/relative to the surrounding fluid.

For either or both of the first and second aspects:

The means of transportation may be a vehicle such as a car, a boat, or a train.

The or each motor may be described as a propulsion motor as it is arranged to propel the vehicle.

The fluid may be air, and the fluid inlet may therefore be an air inlet. Therefore there is provided a means of transportation comprising at least one motor arranged to propel the vehicle, an air inlet and at least one generator, the generator being arranged to generate energy from a passage of air from the air inlet through or over the generator and to drive the or each motor. Alternatively, the fluid may be water.

It will be appreciated that any relative movement between the transportation means (e.g. a vehicle) and any surrounding fluid (e.g. air of the atmosphere, or water through which the vehicle is travelling) may be used to drive the generator, so generating power.

The vehicle may comprise an electrical system.

Multiple inlets may be provided in some embodiments.

Preferably the generator comprises a generator array. The generator array may comprise a plurality of individual generators. In preferred embodiments one or more of the plurality of generators can be switched on or off in accordance with energy load requirements of the system, and/or other parameters of the system and/or its surroundings. The individual generators may therefore be independently controlled. It will be appreciated that this enables the generator array to vary the power being generated. Additionally, the energy required to turn the array at low speeds of airflow (or other fluid flow) or at start up may vary.

Preferably the switching on or off of individual generators may be controlled by an on-board control system.

Desirably the generator is arranged to convert fluid flow energy to electrical energy.

In a preferred embodiment the generator comprises an air flow capture mechanism. Air flow energy is derivable from the flow of gases over the air flow capture mechanism. The flow of gases is provided by movement of the vehicle through the atmosphere—it will be appreciated that this relative movement may comprise movement of the fluid due to e.g. wind, as well as movement of the vehicle in its direction of travel. The air flow capture mechanism is arranged to extract energy from the movement of the vehicle through the atmosphere in a manner that is analogous to a wind turbine capturing wind energy from a flow of wind over the turbine. The flow of air over and through the air flow capture mechanism provides the energy that is converted to electrical energy. In other embodiments, the role of the atmosphere through which the vehicle travels may be fulfilled by any surrounding fluid (surrounding all or part of the vehicle), e.g. by water of an ocean, river, lake, or similar when the fluid used to drive the generator is water.

A rotation axis of the airflow (or other fluid-flow) capture mechanism may be transverse to the vehicle's direction of travel, and optionally may be at least substantially parallel to a width of the vehicle. The rotation axis of the airflow capture mechanism may be at least substantially horizontal.

The air flow capture mechanism may not comprise a powered turbine engine.

In some embodiments the air flow capture mechanism may comprise one or more blades.

The generator array may comprise an array of curved blades. The curved blades may form a part of the flow capture mechanism of the generator array.

The generator array may comprise an electric motor, which may be arranged to, or engageable to, drive the generator. The transportation means may comprise at least one electric motor arranged to propel the transportation means—that propulsion motor, or a separate motor, may be engageable to drive the one or more generators and may therefore be described as a generator drive motor.

The transportation means (and more specifically, the generator of the transportation means) may comprise a fluid flow capture mechanism (e.g. an air flow capture mechanism) with a central hub having a rotation axis around which the central hub and blades extending therefrom are driven to rotate by the flow. This rotation axis, which may be described as a rotation axis of the generator, may be perpendicular to the direction of travel of the transportation means, and may be parallel to a width of the transportation means. This rotation axis may be at least substantially horizontal. The axis may therefore extend along a width of a vehicle providing the transportation means. The blades may extend along at least a portion of the width of vehicle, in the axial direction, as well as extending away from the axis, in a radial direction. The blades may be curved. In embodiments with multiple generators, each may share the same fluid flow capture mechanism, or each may have its own fluid flow capture mechanism, optionally located on the same rotation axis (or alternatively on a separate rotation axis parallel thereto).

After leaving the fluid flow capture mechanism, the air (or other fluid) may then be exhausted from the transportation means via an exhaust section of ducting—i.e. the used fluid flow may leave a vehicle through an exhaust duct. The exhaust duct may comprise at least one Venturi intake, and optionally may comprise a plurality of Venturi intakes; having one Venturi intake between each subsequent pair of sections of the exhaust duct. Air (or other fluid) from around or below the vehicle may be drawn into the exhaust duct through gaps between the exhaust sections in the region of the Venturi intakes, adding to total airflow through the exhaust outlet. This use of Venturi intakes may in effect “pull” the fluid flow through the system more rapidly, improving efficiency. For a vehicle such as a car, the exhaust outlet may be located anywhere across the rear of the car. For a vehicle such as a train, which may have an additional carriage behind a front section, to exhaust outlet may be offset from a centre of the train, and may be outwardly and rearwardly directed so as to avoid impacting on the front of the following carriage.

The transportation means may comprise a first fluid inlet in fluid communication with the first duct. In embodiments with a second duct, the transportation means may comprise a second fluid inlet in fluid communication with the second duct. The second fluid inlet may be above the first fluid inlet.

According to an aspect of the invention there is provided a transportation means comprising at least one motor arranged to propel the transportation means, an air inlet and at least one generator, the generator being arranged to generate energy from a passage of air from the air inlet through or over the generator and to drive the or each motor, the generator comprising an air flow capture mechanism arranged to extract energy from movement of the vehicle through the atmosphere and comprising one or more blades extending from a central hub. It will be appreciated that other fluids, e.g. water, may be used in place of air.
According to another aspect of the invention there is provided a transportation means comprising at least one motor arranged to propel the transportation means and a generator array comprising one or more curved blades mounted on a generator and an electric motor.
According to a further aspect, there is provided a transportation means comprising:
a generator comprising blades extending from a rotatable hub and being arranged to generate energy from a passage of fluid through or over the generator;
at least one fluid input duct, arranged to direct fluid flow to the generator;
a third duct and a fourth duct;
at least one forward-facing fluid inlet arranged to provide a fluid flow to the at least one fluid input duct, and to the fourth duct;
a cowling surrounding the generator and comprising an air outlet behind the generator, and wherein the at least one fluid input duct enters the front of the cowling and the fourth duct extends rearwardly below the cowling;
at least one upward-facing fluid inlet located above the cowling and arranged to provide a fluid flow to the third duct, and wherein the third duct extends vertically behind the cowling, and the air outlet from the cowling enters the third duct, and wherein the third and fourth ducts join at a Venturi junction below and rearward of the generator; and
an exhaust duct extending rearwardly from the Venturi junction and arranged to exhaust all airflow through a rearward exhaust outlet.

Any or all of the features described above for other aspects may be used in conjunction with this aspect.

The transportation means may comprise a first duct and a second duct, both arranged to direct fluid flow to the generator, wherein the first duct has an outlet directing fluid flow towards a lower portion of the blades of the generator, and the second duct has an outlet directing fluid flow towards an upper portion of the blades of the generator. These ducts may be referred to as fluid input ducts as they supply fluid flow to the generator.

The transportation means may comprise at least one motor arranged to propel the transportation means. The generator may be arranged to drive the or each motor.

The transportation means may be a vehicle, and may more specifically be a road vehicle such as a car. The transportation means may have any or all of the features as described with respect to the preceding aspects.

In embodiments with two or more fluid input ducts, the first duct may be located below the second duct. The first duct may direct air upwardly towards the lower portion of the blades of the generator, so lifting the blades. The second duct may direct air rearwardly, and optionally also in part upwardly, towards the upper portion of the blades of the generator, so pushing the blades above the central hub rearwardly.

The fourth duct may be located below the first and second ducts, and may be located at or near the underside of the transportation means.

The inlet to the second duct may be above the inlet to the first duct. The inlet to the fourth duct may be below the inlet to the first duct. The inlets to the first, second, and fourth ducts may all be forward-facing and located in a front region of the transportation means, e. g in the “nose” of a vehicle. For example, for a car, the inlets may be located in the region of the headlights and front grille/bumper. The first, second, and fourth inlets may all be forward of the generator(s).

The inlet to the third duct may be differently-located, for example being located on or across a bonnet (British English) or hood (American English) of a car, or across a roof of a train. For example, the third inlet may extend across at least a portion of the bonnet's width, and may be located towards a rear of the bonnet, for example near to the lower edge of a windscreen of the vehicle. The third inlet may be located level with, or rearward of, the generator(s).

Fluid flow in the third duct may be at least substantially perpendicular to fluid flow in the fourth duct.

Fluid flow in the third duct may be at least substantially perpendicular to fluid flow in the at least one fluid input duct (e.g. at least substantially perpendicular to fluid flow in the first and second ducts).

The third duct may be at least substantially perpendicular to a rotation axis of the generator. The third duct may be at least substantially vertical.

A rotation axis of the generator may at least substantially perpendicular to fluid flow in any or all of the first, second, third, and fourth ducts.

The exhaust duct may comprise at least one Venturi intake. A Venturi intake may be located between two adjacent exhaust sections.

The exhaust duct may be narrowest at its rearward exhaust outlet (to the rear of the transportation means).

The transportation means may comprise at least one motor arranged to propel the vehicle, and the generator may be arranged to drive the at least one motor.

The transportation means may comprise at least one energy storage bank, and the generator may be arranged to charge the energy storage bank.

In any of the aspects described herein:

The generator may comprise a generator array. The generator array may be mounted transversally or vertically in some embodiments, although a horizontal transverse mounting is preferred in others. The generator array may be mounted in or on the front or rear of the transportation means.

The generator (or each generator of the array) may be mounted transverse to a direction of travel of the transportation means. The generator (or each generator of the array) may be mounted across the width of the transportation means, optionally having a rotation axis parallel to the width of the transportation means.

A (first) duct may be used to guide air-flow (or other fluid flow, as applicable) to a generator which is oriented transverse (and optionally perpendicular) to the vehicle's direction of movement, such that the rotation axis of the generator is generally at least substantially perpendicular to the airflow, and parallel to a width of the vehicle (and therefore horizontal in typical vehicle orientations).

Multiple ducts may be used in some embodiments.

The transportation means may further comprise a second duct. The same fluid inlet may be arranged to direct air into the first and second ducts. Alternatively, a separate fluid inlet may be provided for each. The second duct may also be used to guide air-flow (or other fluid flow, as applicable) to a generator which is oriented transverse (e.g. perpendicular) to the vehicle's direction of movement, such that the rotation axis of the generator is generally at least substantially perpendicular to the airflow, and parallel to a width of the vehicle (and therefore horizontal in typical vehicle orientations).

The first duct, and optionally also the second duct in embodiments with a second duct, may be shaped so as to influence the flow direction of fluid therethrough, for example narrowing in the vertical direction so as to raise or lower a vertical mid-point of the fluid flow through the duct, and/or comprising one or more lips or other deflectors to influence airflow direction.

The first duct may have an outlet directing air flow towards a lower portion of the blades of the generator so as to lift the blades, and air from the second duct may be delivered to an upper portion of the blades of the generator, substantially above a central hub of the generator.

The second duct may be provided above the first duct. The second duct may be narrower than the first duct.

The transportation means may comprise a vehicle, such as a car.

The or each blade of a flow capture mechanism may be curved. The or each blade may be arranged to extend from a central hub. The central hub may be rotatable. Curved blades may be at least substantially crescent-shaped. The blades may be arranged such that, for blades positioned between a central hub of the air flow capture mechanism and a front of the transportation means, the tips of the blades curve downwardly. Energy from the flow of air may be captured by the air flow capture mechanism and converted to rotational energy. The central hub may be arranged to be connected to a drive mechanism. The drive mechanism may be arranged to convert rotational movement to electrical energy.

In some embodiments the generator comprises an array of individual generators, and may incorporate the concepts of the inventor's granted UK patent GB2543395B.

Desirably each individual generator is mounted on a support shaft. Each individual generator may be mounted on the support shaft and connected to the air flow capture mechanism. In some embodiments the individual generators are linked together. The individual generators may be linked by ties or may be linked together by other means. The ties may be rigid. Desirably once secured together the individual generators form a rigid generator array.

It will be appreciated that the individual generators may be individually turned on or off by an on-board system.

Desirably each individual generator comprises at least one curved blade forming an air flow capture mechanism. In some arrangements each curved blade may be arranged to be connected to the or each adjacent curved blade such that the adjacent blades form a continuous or semi continuous single blade. In other embodiments each blade may be separated and the individual generators may be linked by a series of rigid ties.

In some embodiments each individual generator may be arranged to comprise a plurality of curved blades which together form the air flow capture mechanism. The plurality of curved blades may be arranged around a central axis of the individual generator. A central hub may be provided from which the or each blade extends. The central hub may be arranged to be connected to the support shaft. The plurality of curved blades arranged around the central hub may comprise a turbine. Where adjacent curved blades are connected together the combined structure may be regarded as being a composite turbine.

The air flow capture mechanism is preferably a part of the generator or generator array. The generator or generator array may be arranged to drive an electric motor, which may in turn propel the vehicle (i.e. a propulsion motor). The generator or generator array may also be arranged to be driven by an electric motor. The generator or generator array may be switchable between a mode in which it drives a motor, and a mode in which it is driven by a motor. The generator or generator array may be arranged to drive or be driven by the same motor, depending on operation mode, or multiple motors may be used—for example an electric motor arranged to drive the vehicle (i.e. an electric propulsion drive motor) may be driven by the generator, and a separate generator array drive motor may be used to drive the generator. In embodiments with multiple motors, the generator or generator array may be arranged to be driven by one motor whilst driving the other motor. Energy stored in a supercapacitor bank, as described below, may be utilised to drive the electric propulsion drive motor(s) or the generator array drive motor(s) Preferably the or each electric motor is integrated within the generator or generator array.

The generator or generator array may be arranged to be mounted transverse to a direction of travel of the transportation means. The air inlet is desirably arranged to direct air to a duct directing the air flow to the air flow capture mechanism of the generator or generator array. The air may flow through the generator or over the generator or generator array. Desirably the air flow from the duct is directed to the or each curved blade of the air capture mechanism and forces the blade or blades and the central hub to rotate such that energy is generated. In one arrangement the duct narrows as it directs air from the air inlet to the air capture mechanism (i.e. getting narrower along its length as it approaches the generator) so increasing the speed of flow of the air as it collides with the or each blade.

The air exiting the duct onto the or each blade forces the blade to turn and to rotate the central hub of the air flow capture mechanism and so rotating the capture mechanism and driving the generator or generator array.

A plurality of grilles may be provided at the front of the vehicle. The grilles may be arranged to be in communication with a plurality of air ducts directing the flow of air from the front of the vehicle to the air flow capture mechanism comprising blades.

It will be appreciated that, as the vehicle gains momentum, air at the front of the vehicle is forced into a duct which narrows, so increasing the velocity of the air at an exit from the duct. In some embodiments as the air exits from the duct it is directed to the curved blade(s) and forces the array to turn generating electricity.

In various embodiments a first duct is provided having a duct intake from a first side to a second side. The first duct can be arranged to extend from a first side of the vehicle to a second side of the vehicle. The first duct may be arranged to have an outlet directing airflow towards a lower portion of the air flow capture mechanism. Air flow from the first duct may therefore be effective to lift the blade. In a preferred embodiment a second duct may be further provided above the first duct. The second duct may have a relatively narrower second intake from a first side to a second side thereof. It will be appreciated that specific ducting sizes (both absolute and relative), ducting routes, and ducting angles may vary depending on the type of vehicle and on the location of the generator within the vehicle.

The second duct is preferably also arranged to transfer air from the second intake to the air flow capture mechanism. The air from the second intake may be delivered to an upper portion of the turbine such that the air from the second intake provides additional rotational force to the turbine. Air flow from an outlet of the second duct may be arranged to be directed at a face of the blade as it rotates so that a maximum force from the air flowing from the outlet of the second duct is transmitted to the air flow capture mechanism. The air flow from the second intake can be described as flowing over the air flow capture mechanism as the direction of flow is substantially over the central hub of the air flow capture mechanism.

Rotation of the central hub of the air flow capture mechanism drives the generator and may be arranged to drive the integrated electric motor within the generator array and which may be arranged to generate electricity.

In a preferred arrangement the generated electricity may be utilised to drive one or more electric drive motors attached to an axle, drive shaft or within the wheel, propelling the transportation means. These electric drive motors may therefore be described as electric propulsion drive motors or electric propulsion motors.

In additional or alternative arrangements, the generated electricity may be used for auxiliary power in addition to, or instead of, propulsive power.

In a preferred arrangement the means of transportation further comprises an energy storage system. Preferably some or all of the generated electricity may be stored in the energy storage system. Energy from the energy storage system may be utilised to power the electric drive motors and propel the transportation means.

As the array turns, electricity is produced and is diverted to the energy storage system or to the electric motor driving the vehicle. As the array turns the electricity may be directed to the on-board energy storage system or to the electric drive motors or to a combination of the two.

Energy may be stored in the energy storage system. The energy storage system may then be used to feed the electric drive motors located within the vehicle wheels or on the axles or on drive shafts that are arranged to drive the wheels. Energy from the generator or generator array or from the energy storage means may in addition (or alternatively) be utilised to power other devices such as heaters, air conditioning, power windows, on-board computers, electronic aids or a multitude of other devices that will be familiar to the skilled person.

In some embodiments an electric motor, such as the propulsive electric motor or a dedicated generator array drive motor, can be engaged to drive the generator or generator array. Either or both such motors may be integrated into the array. It will be appreciated that in some conditions there may not be sufficient air force from air channelled through the duct to turn the generator. In such conditions it may be desirable to engage the integrated electric motor (or other generator array drive motor) in order to drive the generator or generator array.

The energy storage system may comprise a plurality of banks. In a preferred arrangement the energy storage system comprises a first and a second main energy storage bank. The stored energy may be used from the first bank in preference to the second bank. In some embodiments if the first energy storage bank is depleted below a predetermined level then energy from the second energy storage bank may be utilised to raise the energy storage level in the first bank. It may be desirable to utilise energy from the second energy storage bank to drive the integrated electric motor and thus the generator. Energy from the generator may then be utilised to recharge the first energy storage bank or to drive the vehicle drive motors.

In some embodiments the energy storage system may comprise multiple banks which may be arranged for long-term and for short-term energy storage. The first energy storage bank may comprise short-term energy storage banks. The short-term energy storage banks may comprise one or more supercapacitor cells. A plurality of supercapacitor cells may be configured to form two or more supercapacitor banks that can be arranged to hold short-term energy storage. The supercapacitor banks may be arranged to be charged by the generator array or by energy stored in the long-term energy system when required. The energy stored in the supercapacitor bank may be utilised to drive the electric drive motors, e.g. to drive the propulsion motor(s) and/or the generator array drive motor(s). The electric drive propulsion motors may be arranged to propel the vehicle as required.

The second energy storage banks may comprise long-term energy storage banks. The long-term energy storage bank may comprise one or more high energy capacity batteries. Such batteries may be conventional high energy capacity batteries. The batteries may comprise lithium ion cells configured to form a larger capacity battery. The supercapacitor banks may be arranged to be charged by the generator array or by energy stored in the long-term energy system when required. Once the supercapacitor banks have been charged by the long-term energy system the energy in the short-term energy storage system may be utilised to the drive the electric drive motors and propel the vehicle as required.

Desirably a controller is provided as part of the system and the controller is arranged to maintain the energy levels within the storage banks at desired levels—e.g. optimum levels defined based on one or more parameters.

In some embodiments as the energy in this first supercapacitor bank is depleted to a certain point, the system may be arranged to switch over to the second supercapacitor bank and the energy supply is continued to the vehicle drive system without interruption. In some embodiments the first short-term energy storage bank may be charged by energy supplied by the generator array and/or the long-term storage system. This process is repeated as necessary to ensure a continued supply of energy to the vehicle drive system. The long-term and short-term energy storage systems may comprise several modules. The first and the second energy storage modules may be connected in series or parallel. In some embodiments the first and second energy storage systems may comprise a combination of series and parallel arrangements in order to increase the energy outputs of the storage systems.

It may be arranged that the energy requirement for driving the integrated electric motor is less than the power output from the generator array. For example, the vehicle may be operated in an environment where there is insufficient air force being channelled to the blades in order to rotate the generator array i.e. when the vehicle is driven forward below a certain speed. An integrated electric motor within the array (optionally a dedicated generator drive motor) may be arranged to engage to drive the generator array in order to recharge the short-term energy storage system. When the generator array is being driven by the integrated array electric motor the airflow capture blade mechanism may be disengaged from the generator array, optionally via an electromagnetic coupler. The blade mechanism may be disengaged in order to increase the efficiency of the electric motor integrated within the generator array.

The energy to drive the integrated array motor may draw a low amount of energy from the energy storage system. The energy storage system may then be replenished by the higher energy output produced by the generator array.

In some embodiments energy may be produced from a regenerative braking system. An apparatus as described herein may be used for regenerative braking-the generator may be activated as a vehicle is braking, assisting in slowing the vehicle and generating energy as the vehicle's momentum is lost.

In some embodiments solar panels may be incorporated into a vehicle. Solar panels may be incorporated into bodywork of a vehicle. In some embodiments the solar panels may be incorporated into a roof, boot (trunk) or bonnet (hood) portion of the vehicle. Energy from the or each solar panel may be fed into the vehicle's long term energy storage system or may be fed into the vehicle's short term energy storage system.

The system may be arranged to maintain the energy storage system at optimal levels.

In some embodiments the transportation means, and specifically a vehicle, may comprise means for connecting the vehicle to a national grid and may be arranged to be chargeable from the grid.

In some embodiments the energy storage banks may be connectable to an electric grid, such as at a charging point. Energy in the energy storage banks may be fed into the electric grid if desired. In some embodiments it may be desirable to draw energy from the connected electricity grid to operate the integrated motor, driving the generator array in order to provide electrical energy to devices in the transportation means and charging the energy storage banks. Any excess electrical energy generated may be returned to the connected electrical grid. In some embodiments the electric motor may be engageable to run the generator array and to recharge the first and/or second storage systems. In some embodiments the electric motor may continue to run the generator array and to feed energy into the grid. The generator array may be arranged to draw energy from the grid to drive the integrated array motor to drive the generator array which will then feed energy back to the grid at a higher capacity than is drawn. This may be achieved via an AC step-up transformer or converter, or by a DC type step-up transformer or converter.

In some embodiments energy generated via the generator array may be stepped up via several transformers and then converted to DC to supply the vehicle's energy requirements. In some embodiments DC to DC converters may be installed to step-up or step-down voltages as required by the vehicles drive systems. In some embodiments DC energy may be converted to AC via an inverter when energy is supplied from the vehicle to the grid. An inverter may be installed within the vehicle.

As an example of the vehicle to grid output; if 10% of the UK's current DVLA registered vehicles (38.4 m) were to adopt this technology, connect to the grid and export only 2000 W each, a total of 76,800 MW of energy could be exported to the grid. Exported energy could be metered at a tariff and credited to the vehicle owner in order to incentivise ownership and offset any additional costs with this technology. The vehicle could also be utilised as an off-grid energy supply to power grid rated appliances.

In preferred embodiments the controller is arranged to receive data relating to energy storage levels, air speed at the entrance to and exit from the duct, generator or generator array speed, direction of energy flow, integrated electric motor on/off switch and/or motor speed, voltage and current of energy flow, integrated motor, energy feed to the grid or energy flow from the grid and from temperature and other data sensors. The controller may be arranged to output control signals and/or commands to the integrated motor, generator(s) (e.g. turning one or more generators on or off, for example by disengaging/engaging them), at least first and second energy banks, devices in the transportation means, the electric drive means (e.g. propulsive electric motor), and sensors. The controller may be an onboard computer.

The means of transportation may be a passenger or freight transportation means. The transportation means may be an aircraft or a train (e.g. for use on railways) or a vehicle (such as a road vehicle) or a waterborne vessel.

The invention(s) will be further described in relation to a vehicle in particular but it will be appreciated that the principles described could be applied to alternative means of transportation without deviating from the inventive concept.

The invention(s) as described herein may be used as part of a regenerative braking system, to generate electricity from the relative movement between a vehicle and surrounding air (or other fluid) as the vehicle is braking. In the case of a land vehicle and in particular road vehicles, the invention may have particular utility when seeking not to accelerate when driving downhill (noting that energy storage/batteries can be provided such that generated power can be stored for later use rather than being used immediately). In addition, or alternatively, when wind speed and direction are favourable, a natural flow within the atmosphere and not resulting from the vehicle's movement can be used. Indeed, if a user parks a car in alignment with wind direction, energy may be generated whilst the vehicle is parked and stored for later use in powering the motor (the car's battery may therefore be recharged whilst the vehicle is not otherwise in use).

The generator(s) may be switched on and off as required to boost energy efficiency—for example, if the vehicle is moving at a higher speed more generators can be switched on, if the vehicle is moving at a lower speed fewer generators will be switched on. The number of generators switched on may be determined based on a desired rate of deceleration, as well as on a current speed—for example, in regenerative braking scenarios, fewer generators may be switched on in a cruise control mode to restrict a car's speed to 30 miles per hour (mph) when travelling downhill than to restrict a car's speed to 70 miles per hour (mph) when travelling downhill, and/or more generators may be switched on when actively braking sharply than when gently preventing acceleration. This is due to the amount of fluid force available to rotate the blades

When the generator is switched off, the bladed turbine may be locked in place, or may be decoupled such that it spins freely with no energy generation from the fluid flow, and/or one or more duct inlets may be closed (e.g. using controllable covers) so as to reduce or prevent fluid flow (or indeed any small debris not blocked by a grille or similar) from reaching the turbine.

The invention will now be described by way of example only with reference to the accompanying drawings in which:

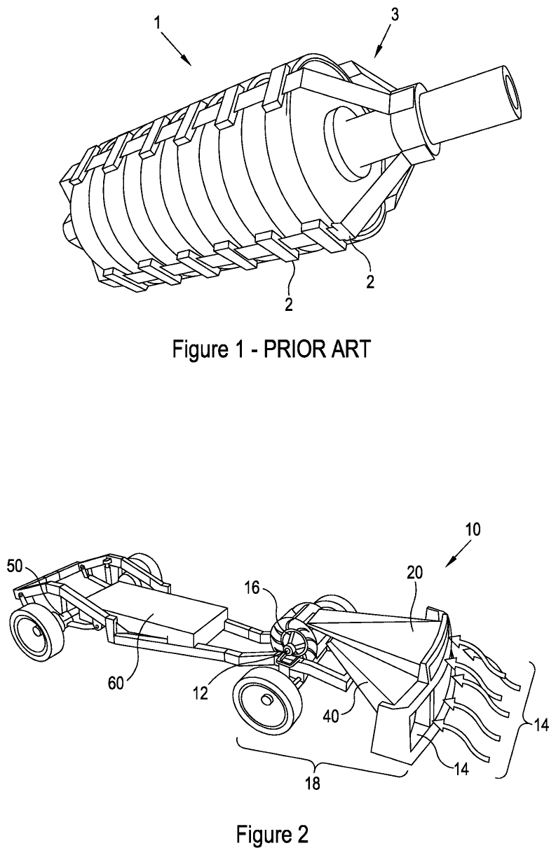

FIG. 1 is a schematic view of a prior art generator (see granted UK patent GB2543395B);

FIG. 2 is a schematic illustration of a vehicle in accordance with an aspect of the invention;

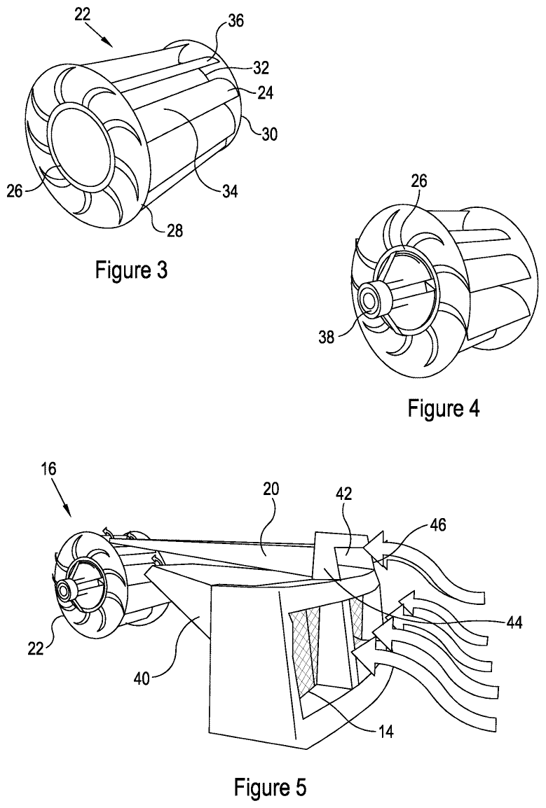

FIG. 3 is a schematic view of a generator for use in a transportation means in accordance with an aspect of the invention;

FIG. 4 is a schematic view of a turbine air foil assembly;

FIG. 5 is a partial schematic of a section of a vehicle in accordance with an aspect of the invention;

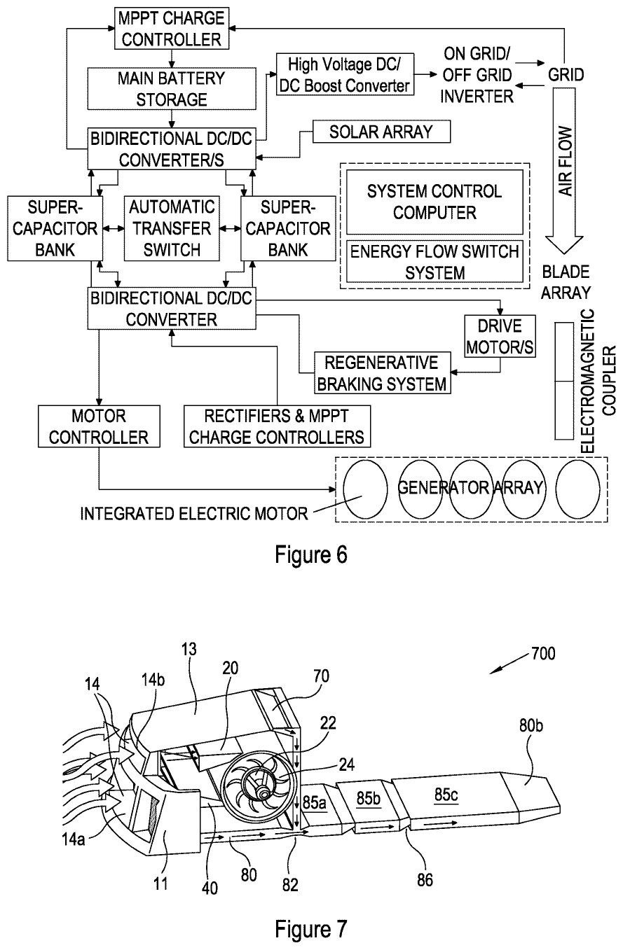

FIG. 6 is a schematic layout of the electrical system;

FIG. 7 is a first perspective view of a vehicle duct system arranged to direct a fluid around a generator;

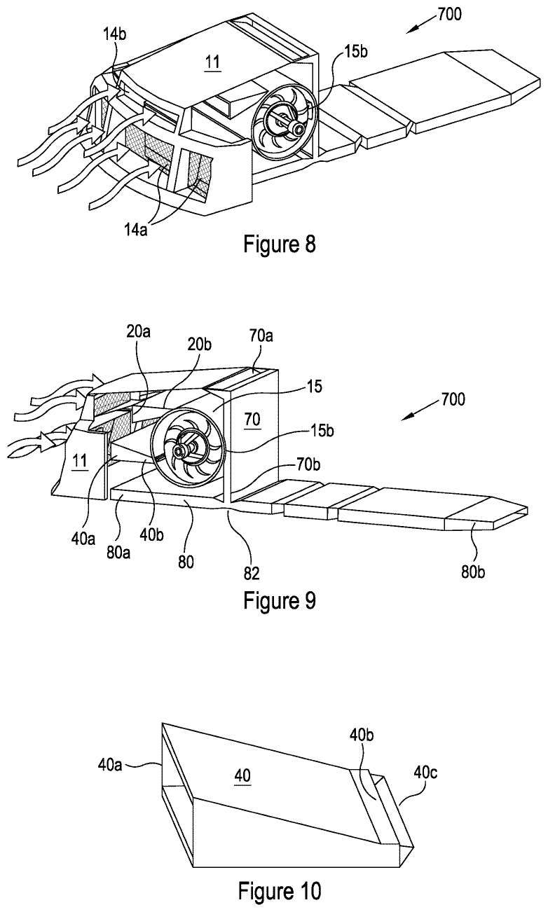

FIG. 8 is a second perspective view of the duct system of FIG. 7;

FIG. 9 is a third perspective view of the duct system of FIG. 7;

FIG. 10 is a perspective view of the first duct in isolation, showing its lip; and

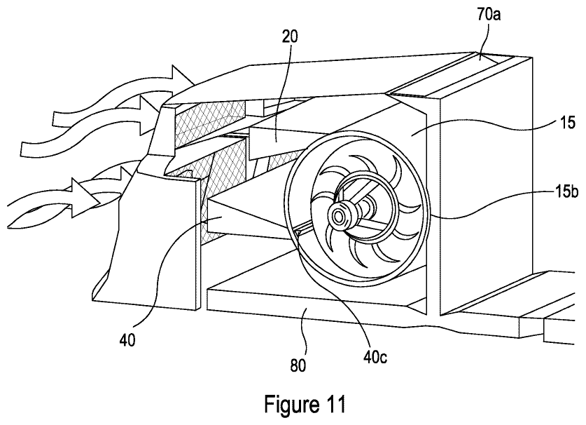

FIG. 11 is a close-up view of a portion of FIG. 9.

FIG. 1 is an illustration of a prior art generator 1 of the applicant illustrating the concept of utilising natural flows of energy to generate power. The prior art generator 1 is also an invention of the current applicant and is based on the concept of utilising natural flows of energy for the production of electrical energy for a number of applications. In the embodiments described herein, wind (or another fluid flow) around the vehicle may drive the generator(s) even when the vehicle is stationary, and may contribute to (and potentially dominate, in cases of slow movement or strong wind) flows when the vehicle is in motion. It will be appreciated that any relative movement between the fluid surrounding the vehicle and the vehicle may be used to drive the generator, potentially combining natural flows and “artificial” flows caused by an engine or motor of the vehicle itself. Further, if a vehicle is moving downhill, the relative movement may be partially or completely due to gravity, so allowing some of the released gravitational potential energy to be captured. If the generator is used as part of a regenerative braking system, whilst the initial movement of the vehicle with respect to its surroundings may have been created using fossil fuels or on-board stored energy, that work has already been done and the ongoing air-flow is a natural result of the vehicle's momentum—that momentum can be captured to generate power.

Similarly, wave motion or river currents may be used to drive a water-driven generator in some vehicles.

Particular benefits may be obtained in certain situations, for example, when wind speed and direction are favourable, that natural flow within the atmosphere, not resulting from the vehicle's movement, can be used to generate power. Indeed, if a user parks a car in alignment with wind direction, energy may be generated and stored (e.g. using one or more energy storage banks as described herein) whilst the vehicle is parked for later use in powering the motor (the relative movement of the car and atmosphere being provided by the captured wind energy alone in this case). In addition, when the vehicle is braking or, in the case of a land vehicle and in particular road vehicles, seeking not to accelerate when driving downhill, the flow rate of air through or over the generator may well be higher than the desired velocity of the vehicle—the technology described herein may be used as part of a braking system, providing regenerative braking.

As described elsewhere herein, the generator(s) may be switched off at some points in vehicle operation, and only switched on when a control system identifies that it is worthwhile to do so. This selective enabling and disabling of the generator(s) may allow for improved efficiency.

One concept utilised by the prior art generator is that of utilising a number of smaller generators 2 that are linked together to provide a generator array 3. The inventor has developed the applications of the generator array to arrive at the present invention.

FIG. 2 illustrates a transportation means 10 in accordance with the present invention. The transportation means 10 comprises a vehicle having an electric drive motor 12, an air inlet 14 and a generator 16. The air inlet 14 is arranged at a first end 18 of the vehicle 10. In use the first end of the vehicle is the front 18 of the vehicle 10 in the direction of normal travel. Air entering the air inlet 14 is contained within an air duct 20 and directed towards the air flow capture mechanism of the generator 16. The generator 16 is arranged to generate energy from a passage of air from the air inlet 14 through or over the air flow capture mechanism of the generator 16.

It will be appreciated that whilst the embodiments currently being described use air as the fluid to drive the generator 16, any suitable fluid may be used—for example, boats, submarines, and other water-borne vehicles or vehicles moving through water may use water as the fluid to drive the generator in place of air. References to the use of air herein are therefore not to be taken as limiting, but rather mentioned by way of example.

The air flow capture mechanism of the generator 16 will now be described in more detail with reference to FIGS. 3 and 4.

FIG. 3 represents a turbine 22 of the generator 16 and comprises a number of curved blades 24 arranged to extend from a central hub 26. Each blade 24 has a substantially aerofoil configuration and extends outwardly from the central hub 26. Each blade 24 further extends from a first side wall 28 to a second side wall 30. Air from the inlet is forced into a space 32 between a first blade 34 and a second blade 36 and the force of the air in the space 32 acts on the first blade 34 exerting a rotational force on the turbine 22. The air flow capture mechanism comprises the arrangement of the blades and the central hub. Rotation of the central hub drives the generator converting air flow kinetic energy to electrical energy.

As illustrated by way of example in FIG. 4 the central hub 26 is connected to a support shaft 38. In some embodiments the central hub 26 is arranged to be disengagably connected to the support shaft 38. The support shaft 38 can be directly or indirectly connected to an electrical energy generator. The electrical energy generator can be conventional and will not be further described here as various alternative arrangements are well known to the skilled person.

In the examples described herein, the support shaft 38 is directly, and optionally rigidly, connected to a generator, or generator array 16. As such, no use of belts, pulleys, gears, cogs, chains or other linkages is required to connect the airflow capture mechanism to the generator 16. The rotation axis of the fluid flow capture mechanism—e.g. a bladed central hub as described herein—may therefore also be (or be collinear with) a rotation axis of the electrical generation part of the generator (e.g. the axis of the rotor and stator). The electrical energy generator may be mounted on the same shaft 38 as the fluid flow capture mechanism, and may be integral with the fluid flow capture mechanism. This may reduce the number of moving parts, and the distance over which rotational movement has to be conveyed, as compared to earlier systems, and may provide a very simple and reliable low maintenance system. A very high efficiency of the generator—for example over 90% and optionally over 96%—may be obtained.

It will be appreciated by the skilled person that it is possible to utilise the generator array arrangement of the invention of granted UK patent GB2543395B. It will be appreciated that in some embodiments the generator comprises an array of individual generators. Desirably each individual generator is mounted on a support shaft and is connected to the airflow capture mechanism. The individual generators are linked together by rigid ties or by other means such that the individual generators link together to form a rigid generator array. It will be appreciated that other aspects of the generator are same whether the generator is a single unitary generator or comprises a generator array.

The electrical energy generator can be arranged to incorporate an electric motor and in a preferred embodiment the electric motor is integral with the generator, i.e. it is provided as a part of the generator.

An arrangement of the generator or generator array in the vehicle is illustrated in more detail in FIG. 5.

Desirably the electrical generator array comprises an array of a plurality of individual generators. Desirably one or more of the plurality of generators can be switched on or off, for example in accordance with energy load requirements of the electrical system and/or in accordance with fluid flow and vehicle motion conditions. It will be appreciated that control of the switching on or off of the individual generators can be controlled by an on board computer.

The generator or generator array 16 is arranged to be mounted transverse to a direction of travel of the vehicle 10. The generator or generator array is arranged to be at a first end 18 of the vehicle, that is, a front of the vehicle in the course of normal direction of travel of the vehicle. A plurality of grilles 14 are provided at the front of the vehicle and the grilles 14 are in fluid communication with a plurality of air ducts 20, 40 directing the flow of air from the front of the vehicle to the air flow capture mechanism of the generator 16. A first duct 40 is provided having a duct intake from a first side to a second side. The first duct 40 can be arranged to extend from a first side of the vehicle to a second side of the vehicle. A second duct 20 is further provided which in this embodiment is located relatively above the first duct 40. The second duct 20 has a relatively narrower second intake 42 from a first side 44 to a second side 46 thereof. The second duct 20 is arranged to transfer air from the second intake to the generator. The air flow from the second intake can be described as flowing over the turbine 22 as the direction of flow is substantially over the central hub of the air flow capture mechanism. The air from the second intake is delivered to an upper portion of the turbine such that the air from the second intake provides additional rotational force to the turbine as the air from the second duct is arranged to collide with the face of the blade as it rotates over the central hub.

The first duct 40 of the example shown in FIGS. 2 and 5 is upwardly angled such that the incoming fluid flow moves vertically upward, as well as rearward, as it moves through the first duct 40. The first duct 40 also narrows rearwardly, with the lower surface of the duct rising more than the upper surface of the duct, so causing the airflow to increase in speed along the duct 40.

Similarly, the second duct 20 of this example is slightly upwardly angled, although to a lesser extent—the upper surface of the second duct 20 is at least substantially horizontal, whereas the lower surface of the second duct rises to narrow the second duct. Again, the narrowing accelerates fluid flow through the duct.

In this embodiment the generator 16 is mounted transversally in the front of the vehicle 10. In other embodiments the generator may be mounted transversally in a rear of the vehicle.

This transverse mounting, with the rotation axis of the generator(s) oriented across the width of the vehicle, allows air to be directed towards the blades of the generator(s) 16 from below, so pushing them upwards to rotate them (e.g. from the first duct 40 as described above, which may be relatively low down on the vehicle—in particular below the axis of rotation of the generator(s) 16—and may have an inlet extending across all, or a large part, of the width of the vehicle).

This transverse mounting may also allow a second duct 20, optionally located above the first duct 40, to direct air, optionally from a separate inlet, to an upper part of the blades, pushing them backwards to assist the first air flow from the first air duct with the rotation.

Locating the generators 16 within the vehicle 10, spaced from the air inlet(s) by ducts 20, 40 arranged to direct air flow to where it is desired, may protect the blades from any turbulent flow around the vehicle, so improving operation and efficiency.

Generated electricity is utilised to drive one or more electric drive motors 50 propelling the vehicle in the non-limiting example being described. One or more electric drive motors 50 are arranged to drive axles or wheels of the vehicle. Each wheel may be driven individually or drive motors may be arranged to drive a rear or front wheel axle of the vehicle.

As the vehicle gains momentum air pushes against the front of the vehicle and is forced into the duct. The duct narrows from the intake to an outlet in order to funnel air into a smaller area, so increasing the airflow speed. As the air exits from the duct it is directed to the curved blade and forces the array to rotate. Rotation of the array produces electricity. The electricity may be directed to the electric drive motor.

The vehicle further comprises an energy storage system 60. The system is arranged such that some or all of the generated electricity can be stored in the energy storage system. In some embodiments the energy from the array may be directed to the energy storage system or to the electric drive motors or to both. In some arrangements energy from the energy storage system 60 can be utilised to drive the electric drive motors in order to propel the transportation means. Energy directly from the generator array or from the energy storage system may be used to drive the electric drive motors. The electric drive motors can be arranged to be in the vehicle wheels or can be provided on the or each axle or on drive shafts in order to drive the wheels of the vehicle.

Energy from the energy storage system can be used in addition to or instead of energy direct from the generator array. In some conditions there may not be sufficient air force from air channelled through the duct to turn the generator. In such conditions it may be desirable to engage the electric motor integrated within the generator array (the generator drive motor) in order to drive the generator.

It will be appreciated that energy from the generator array or from the energy storage means may in addition be utilised to power other devices such as heaters, air conditioning, power windows, on-board computers, electronic aids or a multitude of other devices that will be familiar to the skilled person—this may be referred to as providing auxiliary power.

The energy storage system may comprise a plurality of energy storage banks. In this embodiment the energy storage system comprises a first and a second main energy storage bank. Stored energy may be used from the first energy storage bank in preference to energy from the second energy storage bank.

The energy storage system comprises long-term and short-term energy storage. The first energy storage bank comprises short-term energy storage. The second energy storage bank comprises long-term energy storage. The energy storage system can be arranged to comprise banks of long-term storage and short-term storage.

The first energy storage bank can comprise several supercapacitor cells configured to form at least a first and a second supercapacitor banks that can hold short-term energy storage. The supercapacitor banks can be charged by the generator array or energy stored in the long-term energy system when required, the energy stored in the first supercapacitor bank can be utilised to drive the electric drive motors that in turn propel the vehicle as required.

The second energy storage system comprises long-term energy storage bank and may comprise several conventional high energy capacity batteries; for example, lithium ion cells configured to form a larger capacity battery.

As the energy in this first supercapacitor bank is depleted to a certain point, the system switches over to the second supercapacitor bank and the energy supply is continued to the vehicle drive system without interruption. The first short-term energy storage bank is then rapidly charged by energy supplied by the generator array and/or from the long-term storage system. This process is repeated as necessary to ensure a continued supply of energy to the vehicle drive system.

The long term and short-term energy storage systems can comprise several modules that can be connected in series or parallel or a combination of series & parallel in order to increase the energy outputs of the storage systems.

A controller (not shown) is provided as part of the system and the controller is arranged to maintain the energy levels at optimum levels. The controller may be arranged to control use of energy such that if the first energy storage bank is depleted below a predetermined level then energy from the second energy storage bank may be utilised to raise the energy storage level in the first bank.

It may be desirable to utilise energy from the second energy storage bank to drive the integrated electric motor of the generator array. Energy from the generator may then be utilised to recharge the first energy storage bank or to drive the vehicle drive motors.

In some embodiments the energy requirement for driving the generator's integrated electric motor is less than the power output from the generator array, e.g. when assisted by an airflow that would not be able to drive the generator alone, but which contributes some energy.

In some embodiments the energy requirement for driving the drive electric motor(s) arranged to propel the vehicle is less than the power output from the generator array. In such cases, the excess energy may be stored for later use.

Should the vehicle be operated in an environment where there is insufficient air force being channelled to the blades in order to rotate the generator array e.g. when the vehicle is driven forward below a certain speed. The integrated electric motor within the array can be engaged to maintain the rotation of the generator array in order to recharge the short-term energy storage system. When the generator array is being driven by the integrated electric motor the airflow capture blade mechanism can be arranged to be disengaged from the generator array via an electromagnetic coupler.

The blade mechanism may be disengaged in order to increase the efficiency of the electric motor integrated within the generator array, by maintaining the inertia of the generator array substantially less energy is required to drive the integrated electric motor.

The energy to drive the integrated array motor is a significantly low draw from the energy storage system. The energy storage system can be replenished by the higher energy output produced by the generator array.

It will be appreciated that energy may additionally be produced from a regenerative braking system as well as from solar panels. Further, a generator 16 as described herein may be used as, or as part of, a regenerative braking system—the blades being driven by airflow around the vehicle as it slows. Solar panels can be incorporated into the bodywork design of the vehicle, roof, boot (trunk) and bonnet (hood) can be fed to the vehicle's long or to the short-term energy storage system.

The controller is arranged to maintain energy levels in the energy storage system at optimal levels.

The energy storage banks are arranged to be connectable to an electric grid, such as at a charging point. It will be appreciated that excess energy in the energy storage banks can be fed into the electric grid if desired. Alternatively it may be desirable to draw energy from the connected electricity grid to operate the integrated motor, driving the generator array in order to provide electrical energy to devices in the transportation means and charging the energy storage banks. Any excess electrical energy generated may be returned to the connected electrical grid. The connection to the electric grid may also be arranged to charge the energy storage banks.

Energy generated via the generator array is stepped up via several transformers and then converted to DC to supply the vehicles energy requirements, DC to DC converters are installed to step-up or step-down voltages as required by the vehicle's drive systems. The DC energy can be converted to AC via an inverter, installed within the vehicle, when energy is supplied from the vehicle to the grid or grid-based storage (or indeed local storage). As an example of the vehicle to grid output; if 10% of the UK's current DVLA registered vehicles (38.4 m) were to adopt this technology, connect to the grid and export only 2000 W each, a total of 76,800 MW of energy could be exported to the grid.

Exported energy could be metered at a tariff and credited to the vehicle owner in order to incentivise ownership and offset any additional costs with this technology. The vehicle could also be utilised as an off-grid energy supply to power grid rated appliances.

The skilled person will appreciate that in the normal way the controller is arranged to receive data relating to energy storage levels, switching of energy storage banks, air speed at the entrance to and exit from the duct, generator or generator array speed, direction of energy flow, integrated electric motor switch on/off, voltage and current of energy flow, integrated motor (e.g. current speed, desired speed or power output, torque), energy feed to the grid or energy flow from the grid and from temperature and other data sensors. The controller is arranged to output control signals and/or commands to the integrated motor, at least first and second energy banks, devices in the transportation means, the electric drive mean, and sensors. The controller can be an on-board computer (e.g. the on-board control system mentioned above).

A diagram of the system is set out in FIG. 6 of the Figures.

The first and second ducts 20, 40 together may be described as a duct system or ducting and serve to guide fluid through a part of the vehicle and to a turbine 22 of a generator 16. In other embodiments, more ducts may be provided.

FIGS. 7 to 9 illustrate an alternative duct system 700. The duct system 700 comprises a first duct 40 and a second duct 20 substantially as described above, and therefore has two fluid input ducts 20, 40. More or fewer fluid input ducts may be provided in other implementations-for example only one fluid input duct, or three or four fluid input ducts.

The first duct 40 and second duct 20 are inlet ducts that capture airflow from the front of the vehicle 10. The inlet 40a, 20a of each duct 40, 20 is positioned at or behind the bumper 11 of the vehicle 10 in the example shown, and beneath the vehicle's bonnet 13.

The bumper 11 is arranged to provide one or more fluid inlets 14a, 14b in the form of openings in the bumper 11, covered by grilles 14 in the example shown to prevent ingress of foreign bodies (e.g. leaves, grit, litter, birds). In the example shown, the bumper 11 has a first fluid inlet 14a in a lower part of the bumper 11 and extending across most of the width of the vehicle 10 and a second fluid inlet 14b above the first fluid inlet 14a, and extending across a lesser proportion of the vehicle's width (e.g. around two thirds of the extent of the first fluid inlet 14a). Both inlets 14a, 14b are centrally-located with respect to the vehicle's width. The second fluid inlet 14b is also shallower than the first fluid inlet 14a in the example shown, having a height of around 30-40% of the height of the first fluid inlet 14a. This may vary between implementations, for example influenced by vehicle shape and/or generator width.

The inlets 14a, 14b of the example shown are separated by a solid horizontal bar of the bumper 11, which may be structural. In the example shown, the first inlet 14a is shown divided into three—with a larger central section and smaller edge sections—by solid vertical bars. These may again be structural. It will be appreciated that inlet numbers, shapes, sizes, and arrangements may vary between vehicles 10, and between implementations for a given vehicle 10, and that the example shown is provided for reference only and is not limiting.

The first duct 40 is positioned behind the bumper 11, in a middle region of the inlets in the bumper 11. The airflow created by the motion of the vehicle 10 enters the front 40a of the first duct 40 and is then accelerated via the narrowing of the duct 40, such that the airspeed velocity has increased by the time the air reaches the duct outlet 40b. It will be appreciated that the duct size and angle may be varied as appropriate depending on factors including the vehicle dimensions, generator dimensions, torque required to turn the generator, and the precise location and orientation of the generator within the vehicle.

The airflow is then directed through a cowling 15 of the generator array 16, 22 to lift the blades attached to the generator array 22, so driving rotation of the generator. The first duct 40 directs air onto the blades 24 below the central hub 26 of the turbine 22, lifting the blades upwards. In the example shown, and as clarified in FIGS. 10 and 11, the first duct 40 comprises a lip 40c at its outlet 40b, the lip being angled so as to direct the airflow at an angle upwardly, lifting the blades. The lip 40c may partially deflect the incoming airflow. In alternative implementations, the duct 40 as a whole may be differently angled—e.g. upwardly angled rather than being substantially horizontal, and no lip 40c may be present for airflow adjustment.

The second duct 20 is positioned near the top of the inlets 14a, 14b in the bumper 11. The airflow created by the motion of the vehicle 10, and/or by wind, enters the front 20a of the second duct 20 and is then accelerated via the narrowing of the duct 20, such that the airspeed velocity has increased by the time the air reaches the duct outlet 20b. The airflow is then directed through the cowling 15 of the generator array 16, 22 to push the blades attached to the generator array.

The size of the duct inlets 40a, 20a and length of the ducts 40, 20 will depend on the type, size, and geometry of vehicle 10. For the example of a typical, medium-size, car 10, the duct inlets 40a, 20a may have dimensions of approximately 500 mm (width)×300 mm (height), and may be substantially rectangular in shape.

In the example shown in FIGS. 7 to 11, the front openings/grille 14 extend further across the vehicle's width lower on the front of the vehicle (lower grille 14a), but are narrower higher up (upper grille 14b), for example due to a need to accommodate other vehicle features, e.g. headlights, to either side of the grille 14b. The second duct 20, behind the upper grille 14b, may therefore have a smaller width at its inlet 20a than the first duct 40 has at its inlet 40a, behind the lower grille 14, in some implementations.

At least one of these inlet dimensions would generally taper or narrow along the length of the duct 40, 20, for example having a height reduced by about 50-60% by the outlet 40b, 20b of the duct. The width (parallel to vehicle width) may reduce or stay constant, for example dependent on generator width and/or other vehicle components in the vicinity which the duct must avoid. In the example shown in FIG. 5, the generator 16 is much narrower than the vehicle 10, so the duct width 20, 40 also decreases significantly from the inlet 14, so as to match, or be smaller than, the generator width at the outlet. By contrast, in the example shown in FIGS. 7 to 9 the generator 16 extends across most of the width of the vehicle 10, so the duct width does not decrease significantly from the inlet 40a, 20a to the outlet 40b, 20b. The change in width of the duct along its length may therefore depend on generator size, and the duct outlets 40b, 20b may be sized to match the generator width (see the example of FIG. 7) or to fall fully within the generator width and be narrower than the generator (see the example of FIG. 5). The decision on duct width may be influenced by the relative position of other vehicle components in the vicinity of the ducts 20, 40, and aerodynamic factors of the generator blades, amongst other considerations.

The ducts 40, 20 may have a length of between 100 mm and 500 mm, and optionally around 200 mm. it will be appreciated that this length may vary depending on vehicle dimensions and generator location within the vehicle 10.

In the example of FIGS. 7 to 9, a cowling 15 surrounds the generator 16. The cowling 15 is substantially cylindrical in shape in the example shown, closely surrounding the generator 16. The first and second ducts 40, 20 pass through the cowling 15 such that their outlets 40b, 20b are within the cowling 15, and in front of the central hub 26 of the turbine 22, ensuring that the airflow is directed to the blades 26. Each outlet 40b, 20b takes the form of a rectangular slot in a forward portion of the cowling 15 in the example shown, extending horizontally across the full width of the generator 16 (which is less than the bumper width, and generally less than the width of the first inlet 40a).

The cowling 15 further comprises an airflow exit 15b rearward of the generator 16, through which the air can leave the cowling 15. The cowling airflow exit 15b is located behind and level with the central hub 26 of the turbine 22 in the example shown. The cowling airflow exit 15b takes the form of a horizontal strip opening extending along the length of the cowling, parallel to the vehicle's width and to the generator's rotation axis. It will be appreciated that different arrangements may be used in other embodiments.

The duct inlets 40a, 20a are shown spaced behind the grille 14 of the bumper 11 in the example shown mainly for ease of representation—in reality, the duct inlets 40a, 20a would generally be immediately adjacent the grille, if not in contact with it.

The duct outlets 40b, 20b take the form of elongate horizontal slots in the cowling 15 of the generator 16 in the example shown, although the ducts 20, 40 may extend within the cowling in some implementations, and may have a lip 40c extending within the cowling 15 in some implementations. As compared to the duct system shown in FIG. 5, the outlet 40b of the first duct 40 of the duct system 700 shown in FIGS. 7 to 9 is a little lower, generally being below the central hub 26 of the turbine 22 rather than approximately level with it. The outlet 20b of the second duct 20 is in at least substantially the same position relative to the generator in both duct systems.

The duct system 700 shown in FIGS. 7 to 9 additionally comprises two further ducts—a third duct 70, and a fourth duct 80.

The third duct 70 is a NACA-style inlet duct that captures air flowing over the bonnet 11 of the vehicle 10. The inlet 70a of the third duct 70 may be elongate, extending across at least a portion of the width of the bonnet 11. The bonnet 11 may provide a grille to cover the inlet 70a in some implementations. The inlet 70a of the third duct 70 may be located rearward of the generator 16, and optionally towards a rear of, or behind, the bonnet 11. For example, the inlet 70a of the third duct 70 may be located near a base of the vehicle's windscreen. A NACA duct, also referred to as a NACA scoop or NACA inlet, is a common form of low-drag air inlet design, and in this system 700 is positioned flush with the bodywork so that it does not impede the aerodynamic properties of the vehicle shape. After the angled inlet in or adjacent to the upper surface of the vehicle's bonnet 11, the third duct 70 becomes substantially vertical, guiding the air downwards within the vehicle 10.

Use of this duct 70 has been found to improve the aerodynamics of the vehicle 10 with a duct system 700 as described herein. The airflow created by the motion of the vehicle 10 enters inlet 70a to the third duct and forces air past the exit point 15b of the cowling 15 surrounding the generator array 16. The third duct 70 narrows in the region of the cowling airflow exit 15b, so creating a suction effect which assists in extracting air from the cowling 15. The airflow from and past the cowling airflow exit 15b, within the third duct 70, is then fed into a Venturi junction 82 where the duct narrows, causing the airflow velocity to increase. The Venturi junction also connects the third duct 70 with the fourth duct 80, described below, so the point of the third duct 70 reaching the Venturi junction 82 may be thought of as the third duct's outlet 70b. The third duct 70 therefore assists the flow of air from the first and second ducts 40, 20 past and beyond the turbine 22.

In some implementations, the opening 70a of the third duct 70 comprises a cover—e.g. a flap, valve or door—which can be computer-controlled so as to open and close depending on pre-determined parameters such as airflow requirements, for example. The valve or door may also be closed in instances of heavy rain, and would generally be left in the closed position when the vehicle 10 is parked. When the vehicle is parked or stationary the duct door(s) can be closed to avoid particles or objects for entering the duct system. The cover can be incorporated into the bodywork aesthetics and design of the vehicle 10.

Similarly, one or more controllable covers (not shown) may be provided for the first, second, and/or fourth ducts 40, 20, 80 (the fourth duct 80 being described below). This cover may be a flap arranged to block the duct individually, and/or a cover or screen arranged to block the whole of the openings/grille 14a, 14b providing the forward-facing inlet(s). These may again be controlled to open or close—fully or partially—depending on pre-determined parameters, such as relationships between airflow and current power demand, or in response to a vehicle user braking, or to a cruise control system identifying that the vehicle is desired to maintain a constant speed and is travelling downhill. This control—of some or all ducts—may facilitate use of the generator 16 as part of a regenerative braking system.

The cover(s) may be controlled via the software in an electronic control unit (ECU) within the vehicle 10. For example, sensors may be used to detect speed and acceleration of the vehicle 10, coasting, breaking, airflow, and also drivetrain and onboard stored energy power requirements. Depending on the sensor data, the cover position may be adjusted accordingly to allow, increase, restrict, or prevent airflow to the generator array 16.

If the vehicle 10 is accelerating, or set to a performance mode, the cover(s) may be closed for improved aerodynamic of the vehicle, depending on where the intakes/inlets are mounted. If the vehicle is coasting or breaking, the cover(s) may be opened fully to allow for increased airflow into the generator 16, and so increased power for the motor and/or onboard energy storage system.

The fourth duct 80, like the first and second ducts 40, 20, has an inlet that captures airflow from the front of the vehicle 10. The inlet 80a of the fourth duct 80 is again positioned behind the bumper 11 of the vehicle 10, and beneath the vehicle's bonnet 13. Unlike the fluid input ducts 20, 40, however, this fourth duct 80 does not provide air flow to the generator directly—its outlet is not within the cowling 15 so air entering the fourth duct 80 does not contact the generator 16. The fourth duct may be thought of as a fluid output duct as its flow is used to assist fluid flow to the exhaust outlet, and it does not supply any fluid flow to the generator 16 itself.

The inlet 80a of the fourth duct is located behind a lower part of the first inlet 14a in the bumper 11. The airflow created by the relative motion of the vehicle 10 and surrounding fluid enters the front of the fourth duct 80, and the fourth duct directs the air substantially horizontally and rearwardly within the vehicle, and into the Venturi junction 82 via the narrowing of the duct 80. The Venturi junction, which is substantially T-shaped, connects the third duct 70 to the fourth duct 80, combining their airflows.

The Venturi junction 82 comprises a substantially T-shaped pipe portion, with a vertical inlet from the third duct 70 above the junction, a horizontal inlet from the fourth duct 80 in front of the junction, and a horizontal outlet towards the rear of the vehicle 10, behind the junction. All airflow from all four ducts 40, 20, 70, 80 is therefore eventually exhausted from the vehicle 10 through the same exhaust outlet 80b. The pipe portion is narrowest where the stem of the “T” meets the cross-bar of the “T”—in the example shown, the fourth duct 8 narrows in the vertical dimension as it approaches this intersection (where it is joined by the third duct 70) and then widens again, back to its original depth, after the intersection.

At the exit of the Venturi junction 82, the airflow is directed horizontally towards the rear of the vehicle 10, and to an exhaust duct 85. The exhaust duct 85 may be thought of as a rearward part of the fourth duct 80, behind the generator 16 (and behind the Venturi junction 82). The first exhaust section 85a of the exhaust duct 85 narrows to create an airflow velocity increase and feeds into a wider opening of an additional exhaust section 85b. At the wider opening 86, additional airflow from around the vehicle is drawn/sucked into the exhaust section 85b, this can be repeated in multiple sections 85a, 85b, 85c depending on the size/length of the vehicle 10. These air intakes 86 can be referred to as Venturi intakes as they take advantage of the Venturi effect—the constricted portion of the exhaust section cross-section creating a drop in static pressure and an increase in fluid flow speed which can be used to “suck” in additional air. The airflow eventually exits at the duct outlet 80b to the rear of the vehicle 10. The duct outlet 80b exhausts air from all four ducts 40, 20, 70, 80, and the outlet airflow can be directed to fill the air void behind the vehicle, lessening turbulence and/or the aerodynamic drag of the vehicle 10.

Each exhaust section 85a-c has a narrower outlet than inlet, and the inlet of a next exhaust section 85b-c surrounds the outlet of the previous exhaust section 85a-b. The final exhaust section 85c also narrows to its outlet, accelerating fluid flow behind the vehicle 10. Each exhaust section 85 has an at least substantially rectangular cross-section at each point along its length, with cross-sectional area narrowing towards the Venturi intakes 86. Air from around or below the vehicle 10 is drawn into the gaps between the exhaust sections 85a-c in the region of the Venturi intakes, adding to total airflow through the exhaust outlet 80b.

This use of Venturi junctions and intakes in the ducting pushes the fluid flow through the system more rapidly, improving efficiency.

In the examples described, the ducts 40, 20, 70, 80, 85 are all generally rectangular in cross-section, with a larger width of the cross-section across the width of the vehicle 10 and a much smaller second dimension of the cross-section.

For the first, second, and fourth ducts 40, 20, 80, the second dimension of the cross section is generally at least substantially vertical in use/parallel to the height of the vehicle 10, and the duct extends along at least a portion of the length of the vehicle 10 (from the grille 14 to the generator 16 for the first and second ducts, and the full length of the vehicle of the fourth duct 80, including its exhaust section(s) 85). Fluid flow through these ducts is generally at least substantially parallel to the length of the vehicle, and to the direction of movement of the vehicle (ignoring turbulence). By contrast, for the third duct 70, the second dimension of the cross section is generally at least substantially horizontal in use/parallel to the length of the vehicle 10, and the duct 70 extends along at least a portion of the height of the vehicle 10 (from the top of the bonnet 11 to where it meets the fourth duct 80, at or near an underside of the vehicle 10). Fluid flow through this duct 70 is generally perpendicular to the length of the vehicle, and to the direction of movement of the vehicle (ignoring turbulence).

The fourth duct 80, 85 has an at least substantially constant cross-section along its length, except for around the Venturi junction 82 and Venturi air intakes 86, so the flow is generally horizonal. By contrast, the first 40 and second 20 ducts narrow in height along their lengths, with the angled lower surface of the second duct 20 approaching the more horizontal upper surface of the second duct 20, providing a slight upwards angle for the second duct 20. By contrast to the second duct 20, in the example shown in FIGS. 7 to 11, an angled upper surface of the first duct 40 approaches the more horizontal lower surface of the first duct 40, providing a slight downwards angle for the first duct 40, but the airflow angle is then adjusted upwards by the presence of a deflector lip 40c at the duct's outlet 40b, causing the airflow to move upward and rearward, lifting the generator blades. In other examples, there may be a lip or other deflector provided on the second duct 20 to adjust airflow angle, and/or the first duct as a whole may be upwardly angled and optionally no lip 40c may be provided.

The invention has been described specifically in relation to a car. It will be appreciated that the vehicle may be another passenger or freight transportation means (e.g. lorry (truck), train, or boat). The transportation means may be an aircraft or a train or any other vehicle. It will be appreciated that the principles described could be applied to alternative means of transportation without deviating from the inventive concept. Further, in the case of aquatic vehicles such as boats or submarines, the fluid used to drive the generator may be water instead of air, or both water and air may be used—for example with a lower fluid inlet for water and a higher fluid inlet for air.

1. A transportation means comprising a first fluid inlet, a second fluid inlet, a first duct, a second duct, wherein the second duct is provided above the first duct and is narrower than the first duct, and at least one generator, wherein the first and second fluid inlets are arranged to direct fluid into the first duct and the second duct respectively, and the first and second ducts are arranged to receive a fluid flow from the first and second fluid inlets, and to direct the fluid flow to the generator, the generator being mounted transverse to a direction of travel of the transportation means and arranged to generate energy from a passage of fluid from the fluid inlets through or over the generator, the generator comprising a fluid flow capture mechanism comprising at least one blade extending from a central hub, and wherein the first duct has an outlet directing fluid flow towards the blades of the generator from below so as to lift the blades, and fluid from the second duct is delivered to an upper portion of the blades of the generator, substantially over the central hub, pushing the blades backwards, and wherein the second inlet is narrower than the first inlet in the transverse direction, the fluid flow capture mechanism being arranged to extract energy and drive the generator from movement of the transportation means through the surrounding fluid.

2. A transportation means in accordance with claim 1 wherein the fluid is air of an atmosphere surrounding the transportation means.

3. A transportation means in accordance with claim 1, wherein the generator comprises an array of individual generators, and wherein at least one of the plurality of generators can be switched on/off independently.

4. A transportation means in accordance with claim 1, wherein at least one of the first duct and the second duct narrows towards the generator.

5. A transportation means in accordance with claim 1, further comprising an energy storage system comprising a plurality of energy storage banks.

6. A transportation means in accordance with claim 1, wherein the transportation means comprises at least one electric motor, and wherein
the generator is engageable to drive the at least one motor, and the at least one motor is arranged to propel the transportation means.

7. A transportation means in accordance with claim 1, wherein the transportation means comprises at least one electric motor, and wherein
the electric motor is engageable to drive the at least one generator.

8. A transportation means in accordance with claim 5, wherein the energy storage system comprises a first and a second energy storage bank, wherein stored energy is used from the first energy storage bank in preference to the second energy storage bank, and wherein
the first energy storage bank comprises a bank of supercapacitor cells and the second energy bank comprises at least one larger capacity battery.

9. A transportation means in accordance with claim 5, further comprising a controller and wherein the controller is arranged to maintain energy levels in each energy storage bank at desired levels, and wherein if a first energy storage bank is depleted below a predetermined level then energy from a second energy storage bank is utilized to raise the energy storage level in the first energy storage bank.

10. A transportation means in accordance with claim 9, wherein the controller is arranged to receive data relating to at least one of energy storage levels, fluid speed at the entrance to and exit from the first duct, generator speed, direction of energy flow, voltage and current of energy flow, motor speed, energy feed to/from the grid, temperature data and other data sensors, and wherein the controller is further arranged to output control signals to at least one of an integrated electric propulsion motor, an electric generator drive motor, the generator, at least first and second energy banks, devices in the transportation means, and sensors.

11. A transportation means in accordance with claim 5, wherein the energy storage banks are connectable to an electric grid, such that energy can be moved between the energy storage banks and the electric grid.

12. A transportation means in accordance with claim 1, wherein the second fluid inlet is above the first fluid inlet.

13. A transportation means in accordance with claim 1 wherein
the central hub has a rotation axis around which the central hub and the blades extending therefrom are arranged to rotate, and wherein the rotation axis is perpendicular to the direction of travel of the transportation means and parallel to a width of the transportation means, and wherein the blades extend along at least a portion of the width of the transportation means.

14. A transportation means in accordance claim 1, wherein the transportation means comprises an exhaust duct comprising at least one Venturi intake, and wherein fluid from at least one of the first duct and the second duct is exhausted from the transportation means via the exhaust duct comprising at least one Venturi intake.

15. A transportation means comprising:
a generator comprising blades extending from a rotatable hub and being arranged to generate energy from a passage of fluid through or over the generator;
at least one fluid input duct arranged to direct fluid flow to the generator;
a third duct and a fourth duct;
at least one forward-facing fluid inlet arranged to provide a fluid flow to the at least one fluid input duct, and to the fourth duct;
a cowling surrounding the generator and comprising an air outlet behind the generator, and wherein the at least one fluid input duct enters the front of the cowling and the fourth duct extends rearwardly below the cowling;
at least one upward-facing fluid inlet located above the cowling and arranged to provide a fluid flow to the third duct, and wherein the third duct extends vertically behind the cowling, and the air outlet from the cowling enters the third duct, and wherein the third and fourth ducts join at a Venturi junction below and rearward of the generator; and
an exhaust duct extending rearwardly from the Venturi junction and arranged to exhaust all airflow through a rearward exhaust outlet.

16. The transportation means of claim 15, wherein the at least one fluid input duct comprises a first duct and a second duct, both arranged to direct fluid flow to the generator, wherein the first duct has an outlet directing fluid flow towards a lower portion of the blades of the generator, and the second duct has an outlet directing fluid flow towards an upper portion of the blades of the generator.

17. The transportation means of claim 15, wherein
fluid flow in the third duct is at least substantially perpendicular to fluid flow in the at least one fluid input duct, and to fluid flow in the fourth duct.

18. The transportation means of claim 15, wherein
a rotation axis of the generator is at least substantially perpendicular to fluid flow in any of the ducts.

19. The transportation means of claim 15, wherein
the exhaust duct comprises at least one Venturi intake; and
the exhaust duct is narrowest at its rearward exhaust outlet.

20. (canceled)

21. The transportation means of claim 15, wherein at least one fluid inlet of the transportation means comprises a controllable cover arranged to open and close the inlet.

22. (canceled)
